(19) United States
(12) Patent Application Publication
(10) Pub. No.: US 2005/0087238 A1
(43) Pub. Date: Apr. 28, 2005

(54) Compressed air control system refinements

(76) Inventors: Robert E. Wilson, Tierra Verde, FL (US); Thomas F. Taranto, Baldwinsville, NY (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/963,307

(22) Filed: Oct. 12, 2004

Related U.S. Application Data
(60) Provisional application No. 60/513,240, filed on Oct. 22, 2003.

(51) Int. Cl. G05D 16/20

(52) U.S. Cl. 137/599.07

(57) ABSTRACT

A compressed air control system has a plurality of air-conducting airways connected between upstream and downstream headers. A control valve arrangement utilizes a main analog flow control valve in one of the parallel airways and at least one digital trim valve in another of the parallel airways. The control and trim valves respond to pressure changes in the downstream header and ensure that the control valve never closes more than 25 percent and never opens beyond 75 percent so as to stabilize system pressure.

### CROSS-REFERENCE TO RELATED APPLICATIONS

This application is based on and claims priority from U.S. Provisional Patent Application Ser. No. 60/513,240 filed Oct. 22, 2003.

### FIELD OF THE INVENTION

The present invention generally relates to control systems for pneumatic plant supplies and is particularly, although not exclusively, concerned with an improved air control system for compressed air supplies used to power industrial or commercial equipment and to a complete air system which integrates such air control system with air compressor means and useful air-powered equipment.

### BACKGROUND OF THE INVENTION

Many factories use compressed air as a major source of power for operating their production machinery. The air is typically supplied from on-site or nearby compressors and piped to a downstream use or demand area through a distribution system, with pressure stabilizing storage means being provided upstream, in the form of tanks or receivers. Typical equipment includes pneumatically-powered machine tools, drills, wrenches, presses and lathes, as well as mills and buffers, and low demand spray booths and instrumentation. Such equipment is commonly referred to in the art as the “article”, a generic term connoting anything connected to the air system to make use of the supply.

End users want the air system to maintain adequate pressure to run their air-powered equipment and few consider the energy costs of the air.

Major changes in downstream demand create varying loads on the compressors. Air compressors are typically controlled according to system supply pressure, coming on-line as system pressure at the compressor, or nearby, drops below a threshold pressure and going off-line at a higher cutout pressure. This is necessarily a rather crude control system, especially as air compressors are slow to respond to changes. As factory production drops off, for example at the end of a shift, air demand declines, and this decline can be quite sudden.

System pressure rises substantially to unload compressor horsepower until compressor output can be adjusted and this overpressure can increase the air consumption rate as still operating machinery uses more air and also increases leakage. These overpressure losses constitute an artificial demand resulting in wasted energy. Being designed to maintain a threshold working pressure under conditions of heavy demand, most air systems have used an excess of compressor capacity over the theoretical capacity needed to give satisfactory operational results, with consequent unnecessary capital expenditure and running costs.

U.S. Pat. No. 5,325,884 issued Jul. 5, 1994 addresses the aforementioned drawbacks. In the '884 patent, an air compressor control system employs a plurality of flow controllers or control valves in parallel airways between upstream and downstream header tanks and controls them in response to sensed downstream pressures to stabilize the system. This stabilization improves the efficiency of air use leading to energy savings and better equipment performance and durability.

Control valves used for the control of flow and pressure for gaseous fluids that expand and contract are non-linear in their performance. The best performance is attained when valves are at 50 percent of their range with good control maintained at a range of 20-80 percent. The degree of control diminishes after that as the flow open and flow closed position is approached. The degree of performance degradation depends on the physical configuration of the control valve itself. Eccentric plug, split ball, and globe disk designs are available, for example, to mitigate the condition but add significant cost to the fabrication of the valve. A much less expensive wafer disk, also known as butterfly, design will perform in a satisfactory manner at mid-range, but loses its ability to control pressure under dynamic flow conditions if the wafer disk swings too far open or closed.

Accordingly, it is desirable to provide a compressed air control system having an improved control valve arrangement which will better maintain the efficiency and performance of the system.

### SUMMARY OF THE INVENTION

It is a general object of the present invention to provide an improved pneumatic control system which opens or closes a control valve arrangement to restrict or increase flow by the amount necessary to balance flow in with the system demand to stabilize air pressure.

It is also an object of the present invention to provide a compressed air control valve arrangement which continuously operates in an approximate range of 25-75 percent open.

It is a further object of the present invention to provide a compressed air control valve arrangement which utilizes at least two valves in at least two parallel airways to maintain a stable mid-range operation regardless of flow conditions.

In one aspect of the invention, a pneumatic control system includes an upstream manifold connected to a compressed air supply conduit providing a source of compressed air. A downstream manifold is connected to variable compressed air demand through a delivery conduit. A plurality of airways extend between the upstream and downstream manifolds to distribute compressed air from the supply conduit to the delivery conduit. A main analog flow control valve is disposed in one of the parallel airways to control flow therethrough. At least one digital trim valve is located in at least one other of the parallel airways to control flow therethrough and cooperate with the main analog flow control valve to continuously maintain the main analogue flow control valve substantially 25-75 percent open. An actuator arrangement is connected to the main analog control valve, the at least one digital trim valve and the downstream manifold to actuate the main analog flow control valve and the at least one digital trim valve in response to downstream demand to stabilize the downstream pressure.

Various other objects, features and advantages of the invention will be made apparent from the following description taken together with the drawings.

### BRIEF DESCRIPTION OF THE DRAWINGS

The drawing illustrates the best mode presently contemplated of carrying out the invention.

In the drawing:

FIG. 1 is a schematic diagram of a compressed air control system employing the control valve arrangement of the present invention.

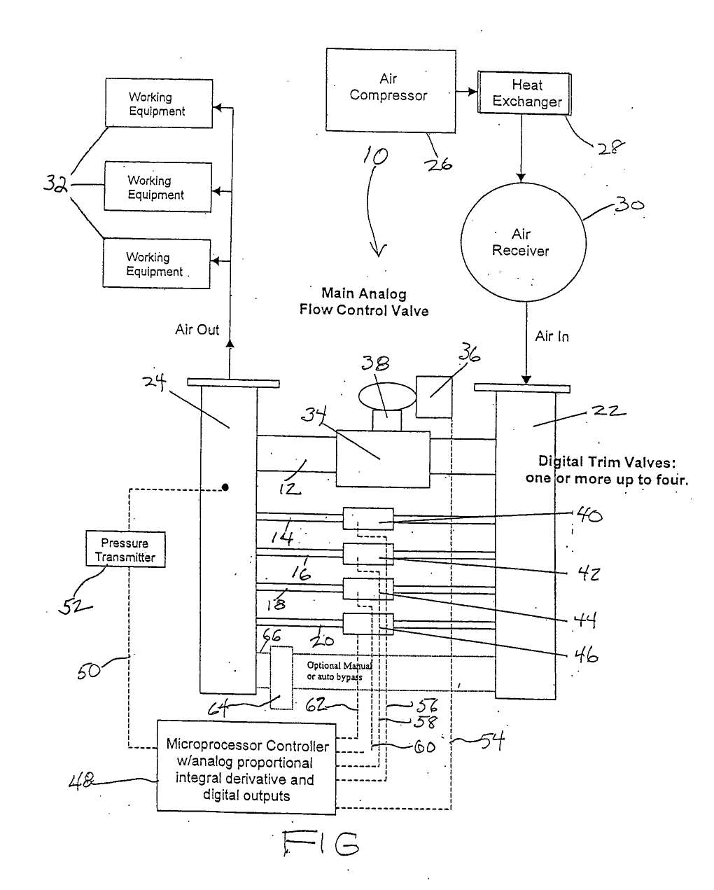

### DETAILED DESCRIPTION OF THE INVENTION

A pneumatic control system 10 includes a main parallel airway 12 and at least one or more secondary parallel airways 14, 16, 18, 20 for delivering air between an upstream header 22 and a downstream header 24. The upstream header 22 is in communication with at least one air compressor 26, a heat exchanger 28 and an air receiver 30 so that pressurized air can be supplied into the system 10. Compressed air is delivered on demand from downstream header 24 to pneumatically-powered working equipment 32 such as machine tools, drills, spray booths and the like.

In accordance with the present invention, a main analog flow control valve 34 is located in the midsection of the main parallel airway 12 for controlling airflow therethrough. The control valve 34 includes a pneumatic actuator 36 and an electronic positioner 38. In the preferred embodiment, the control valve 34 is preferably a Jamesbury wafer-sphere, five inch butterfly rotary valve with a fail closed design position. The Jamesbury valve has a double offset design which eliminates major mechanical deficiencies previously experienced with other wafer style disk designs.

Located midway of the secondary parallel airway 14 is at least one digital trim valve 40 used for controlling airflow therethrough, and for modifying the behavior of the control valve 34 as will be appreciated below. Typically, the digital trim valve 40 takes the form of a Jamesbury series 4,000 two inch standard port, high performance, ball valve with a solenoid with a fail open design. The remaining parallel airways 16, 18, 20, if provided, are each equipped with a digital trim valve 42, 44, 46 in the form of a ball or poppet type valve with a solenoid. Each of the aforementioned valves is commercially available from Simone Engineering, FC Performance FC Inc., in Germantown, Wis.

The control system 10 includes an actuator arrangement having a microprocessor controller 48 with analog, proportional integral derivative (PID) and digital outputs. Controller 48 is coupled by a line 50 to a pressure transmitter 52 which, in turn, is in communication with the air supply in downstream header 24. A cable 54 connects control valve actuator 36 and electromagnetic positioner 38 with controller 48. Dedicated cables 56, 58, 60, 62 respectively connect the controller 48 with the respective solenoids on trim valves 40, 42, 44, 46. The pneumatic control air is tapped off header 22 or off of a port supplied on the inlet of the respective valve bodies provided for this purpose. The system 10 may further include an optional manual or auto bypass 64 connected in a parallel airway 66 between the upstream and downstream headers 22, 24 which bypass fails in the event of loss of the primary control power. One such acceptable bypass 64 may be a spring open, air-to-close Milwaukee six inch butterfly valve.

In use, the main flow control valve 34 is positioned by actuator 36 and electronic positioner 38 responding to an analog signal from pressure transmitter 52. The outlet pressure at the discharge of the valve package is maintained within a tolerance of +/− one percent by positioning the disk in control valve 34 to restrict flow in a controlled manner. Compressed air expands with a resultant decrease in pressure when more air is flowing away from a point than is flowing in. Conversely, if more air flows to a point than is flowing away, the gas compresses and the pressure goes up. The pressure transmitter 52 in communication with the downstream header 24 senses the pressure and sends a signal to microprocessor controller 48 to tell the electronic positioner 38 to open or close the control valve 34 to restrict or increase flow by the amount necessary to balance the flow in with the system demand out to stabilize the pressure. The positioner 38 also senses the degree open and closed of the valve 34. As the valve 34 approaches 75 percent open, a digital signal is sent to the secondary flow parallel airways 14-20 actuating the one or more normally closed poppet/ball valves 40-46 to open. The flow through the poppet/ball valves 40-46 adds to the total flow into the air system 10 causing pressure to increase which, in turn, causes the main control valve 34 to close down by an equivalent amount to again balance the flow. When the positioner 38 senses the valve 34 is closed to approximately 25 percent, the secondary parallel poppet/ball valve 40-46 is closed reducing the flow into the system resulting in the main flow control valve 34 to open and rebalance the system flow. Depending upon the size of the system and the range of dynamic flow demands, multiple parallel poppet/ball valves 40-46 can be arranged to allow sizing the main control valve 34 so that it always operates in the approximate range of 25-75 percent open. The microprocessor controller 48 outputs an analog signal to control the single main flow control valve 34 and up to four digital signals to operate the poppet/ball valves 40-46 in an incremental or decremental sequence. A stable base flow is established in up to four stages to keep the main control valve 34 within its optimum operating range. All valves fail full open in the event the electronic signal is lost, the power fails, or if the control outlet pressure decreases to a preset threshold.

The new control valve arrangement introduces a base incremental flow to ensure the control valve 34 never closes more than 25 percent and never opens beyond 75 percent. A cluster of small parallel flow paths 14, 16, 18, and 20 are installed in parallel with the main flow control valve 34 and are digitally sequenced on or off to add or subtract flow causing the main valve 34 to adjust its position. In the prototype control arrangement, for example, the peak demand is 8,000 scfm. The butterfly valve 34 is selected to flow the full demand at the full open position and 6,000 scfm at about 70 percent open. A two inch ball valve is selected as the base secondary parallel to flow 2,000 scfm. The combined flow capacity would keep the control valve 34 controlling at under 70 percent at less than peak flow condition. The minimum expected flow is 4,500 scfm. With the two inch parallel airway 14 closed, the control valve 34 would be controlling at 56 percent open. Operating with this valve combination ensures that the control valve 34 is always between the target 25-75 percent under normal system demands. As a result, the control valve arrangement enables maintaining a substantially constant downstream pressure further improving the stability and operating efficiency of the system 10.

While the invention has been described with reference to a preferred embodiment, those skilled in the art will appreciate that certain substitutions, alterations and omissions may be made without departing from the spirit thereof. Accordingly, the foregoing description is meant to be exemplary only and should not be deemed limitative on the scope of the invention set forth with the following claims.

1. A pneumatic control system for regulating and providing a source of compressed air to air-operated working equipment, the system comprising:
an upstream manifold connected to the source of compressed air;
a downstream manifold secured to the working equipment;
a plurality of parallel airways extending between the upstream and downstream manifolds for distributing compressed air from the source of compressed air to the working equipment;
a main analog flow control valve disposed in one of the parallel airways for controlling flow therethrough;
at least one digital trim valve located in at least one other of the parallel airways to control flow therethrough and cooperate with the flow control valve to continuously maintain the flow control valve substantially 25 percent to 75 percent open; and
an actuator arrangement connected to the flow control valve, the at least one digital trim valve and the downstream manifold to actuate the flow control valve and the at least one digital trim valve in response to downstream demand to stabilize downstream air pressure.

2. The pneumatic control system of claim 1, wherein the source of compressed air includes at least one air compressor.

3. The pneumatic control system of claim 1, wherein the source of compressed air includes a heat exchanger.

4. The pneumatic control system of claim 1, wherein the source of compressed air includes an air receiver.

5. The pneumatic control system of claim 1, wherein the flow control valve includes a pneumatic actuator and an electronic positioner.

6. The pneumatic control system of claim 1, wherein the flow control valve is a butterfly rotary valve.

7. The pneumatic control system of claim 1, wherein the at least one digital trim valve is a ball or poppet valve with a solenoid.

8. The pneumatic control system of claim 1, wherein the actuator arrangement includes a microprocessor controller connected to a pressure transmitter.

9. The pneumatic control system of claim 1, including a bypass located in another of the parallel airways, the bypass failing open in the event of loss of primary power to the system.

10. In a compressed air control system having an air compressor for supplying compressed air to an upstream header, a downstream header for accumulating compressed air and providing compressed air to working equipment, a plurality of parallel airways connected between the upstream and downstream headers for communicating compressed air between the air compressor and the working equipment, the improvement comprising:
a main analog flow control valve positioned in one of the parallel airways for distributing compressed air from the air compressor to the working equipment;
at least one digital trim valve located in at least one other of the parallel airways for controlling flow therethrough and cooperating with the flow control valve to continuously maintain the flow control valve substantially 25 percent to 75 percent open; and
an actuator arrangement including a microprocessor controller and a pressure transmitter operably connected together to the flow control valve, the at least one digital trim valve and the downstream manifold,
whereby the flow control and trim valves respond to pressure changes sensed by the pressure transmitter in the downstream header and ensure that the flow control valve never closes more than 25 percent and never opens beyond 75 percent to stabilize system pressure.
